(19) United States
(12) Patent Application Publication
(10) Pub. No.: US 2025/0324498 A1
(43) Pub. Date: Oct. 16, 2025

(54) LIGHT-EMITTING DEVICE

(71) Applicant: Bridgelux Optoelectronics (Xiamen) Co., Ltd., Xiamen (CN)

(72) Inventors: CHEN CHU, Xiamen (CN); JING CHEN, Xiamen (CN); DEBING HUANG, Xiamen (CN); JINGQIONG ZHANG, Xiamen (CN); GUOHENG QIN, Xiamen (CN); CONGLIN WU, Xiamen (CN)

(21) Appl. No.: 19/026,530

(22) Filed: Jan. 17, 2025

(30) Foreign Application Priority Data
Apr. 15, 2024 (CN) 2024104520738

(51) Int. Cl. H05B 45/44

(52) U.S. Cl. CPC H05B 45/44

(57) ABSTRACT

A light-emitting device includes a first light source, a second light source, a shunt, and a third light source. The second light source is connected in series with the first light source, and the second and first light sources form a first branch. The shunt is connected in parallel with the second light source and connected in series with the first light source. The third light source is connected in parallel with the first branch, and a color temperature of the third light source is greater than that of the first light source and the second light source. By setting the first, third, and second light source to light up sequentially in that order, making the color temperature of the light-emitting device as a whole gradually shift from the color temperature of the first light source to that of the third light source, thereby presenting a color temperature gradient process.

### CROSS-REFERENCE TO RELATED APPLICATION

This application claims priority to Chinese patent application No. CN 202410452073.8, filed to China National Intellectual Property Administration (CNIPA) on Apr. 15, 2024, which is herein incorporated by reference in its entirety.

### TECHNICAL FIELD

The disclosure relates to the field of photoelectric technologies, and particularly to a light-emitting device.

### BACKGROUND

Traditional incandescent bulbs, as a type of thermal radiation light source, typically use a tungsten filament as a light-emitting element. When the incandescent bulb is connected to an external power supply and current is conducted through the tungsten filament, the tungsten filament is heated to a certain temperature by the current, causing the tungsten filament to emit light. A luminous efficiency of the incandescent bulbs is generally low. For example, the incandescent bulbs with the tungsten filament as the light-emitting element generally have a luminous efficiency of less than 5%, which means that less than 5% of energy obtained by the incandescent bulb is converted into light energy, with the remaining energy being lost in the form of heat. As a result, the incandescent bulbs are gradually being replaced by energy-saving lamps in the market. However, during the illumination process, the light emitted by the incandescent bulbs undergoes a gradual color temperature change process. For light-emitting devices with such the gradual color temperature change process, there is still a market demand. Therefore, designing a lighting fixture that can simulate the color temperature change process of the incandescent bulb is a technical issue that needs to be addressed.

### SUMMARY

To address the technical challenge of simulating the color temperature transition process of incandescent bulbs, the disclosure provides a light-emitting device. The light-emitting device achieves the technical effect of a gradual color temperature change by setting light sources of different color temperatures and using a shunt, which allows the light sources of different color temperatures to light up sequentially.

A light-emitting device is provided, the light-emitting device includes a first light source, a second light source, a shunt, and a third light source. The second light source is connected in series with the first light source, and the second light source and the first light source form a first branch. The shunt is connected in parallel with the second light source and connected in series with the first light source. The third light source is connected in parallel with the first branch, and a color temperature of the third light source is different from that of the first branch.

In an embodiment, a number of the third light source is multiple, the multiple third light sources are connected in series to form a second branch, and the second branch is connected in parallel with the first branch.

In an embodiment, a number of the second branch is multiple, and the multiple second branches are connected in parallel.

In an embodiment, a number of the first light source is multiple, the multiple first light sources are connected in series, and the multiple first light sources are connected in series with at least one second light source to form the first branch.

In an embodiment, a number of the first branch is multiple, and the multiple first branches are connected in parallel.

In an embodiment, the shunt is simultaneously connected with the multiple second light sources of the multiple first branches in parallel; or a number of the shunt is multiple, and the multiple shunts are respectively connected in parallel with the multiple second light sources of the multiple first branches in a one-to-one manner; or the number of the shunt is multiple, and the multiple shunts are connected in parallel with the multiple second light sources of the multiple first branches respectively.

In an embodiment, a number of the third light source is multiple, the color temperature of the multiple third light sources is greater than that of the multiple first light sources and the second light source. The number of the third light sources is greater than a total number of the multiple first light sources and the second light source.

In an embodiment, a number of the first light source is multiple, the multiple first light sources are connected in series, and the multiple first light sources and the second light source form the first branch. A number of the first branch is multiple, and the multiple first branches are connected in parallel. Each of the multiple first branches includes the multiple first light sources and one second light source. Each of the multiple second branches includes the multiple third light sources. The number of the multiple third light sources in each of the multiple second branches is the same as a sum of a number of the multiple first light sources and the second light source in each of the multiple first branches. The multiple first light sources, the second light source and the multiple third light sources include light-emitting diode elements with the same starting voltage.

In an embodiment, the color temperature of the first light source and the color temperature of the second light source are greater than or equal to 1500 Kelvin (K) and less than or equal to 2100 K; the color temperature of the third light source is greater than or equal to 3100 K and less than or equal to 3300 K.

In an embodiment, the first light source, the third light source, and the second light source light up sequentially in that order as a total current of the light-emitting device gradually increases.

The beneficial effects of the disclosure are as follows.

By setting the shunt, when the light-emitting device is powered on, as the total current of the light-emitting device gradually increases, the first light source starts to work first, and the shunt shorts the second light source. As the total current further increases, the third light source begins to work, and at this time, the color temperature of the light emitted by the light-emitting device is a mixed color temperature of the first light source and the third light source, that is, between the color temperatures of the light emitted by the first light source and the third light source. As the total current further increases, the second light source lights up and works, thereby regulating the color temperature of the light emitted by the light-emitting device as a whole, and can make the color temperature of the light emitted by the light-emitting device as a whole stabilize at a specific value as the total current of the light-emitting elements further increases. The light-emitting device, by setting the first light source, the third light source, and the second light source to light up and work in that order, makes the color temperature of the light emitted by the light-emitting device as a whole gradually shift from the color temperature of the first light source to the color temperature of the third light source, thereby presenting a color temperature gradient process similar to that of a gradually lighting incandescent bulb. After reaching a certain specific value, the color temperature of the light emitted by the light-emitting device as a whole stabilizes and no longer changes with the increase of the total current, which can meet the needs of different end users for the same color temperature.

### BRIEF DESCRIPTION OF DRAWINGS

In order to more clearly illustrate technical solutions of embodiments of the disclosure, a brief introduction will be given to the attached drawings required for the description of the embodiments. Apparently, the attached drawings described below are only some embodiments of the disclosure. For those skilled in the art, other drawings can be obtained based on these drawings without creative labor.

FIG. 1 illustrates a current-color temperature curve of a light-emitting device in an embodiment of disclosure.

FIG. 2 illustrates an equivalent circuit diagram of the light-emitting device in the embodiment of the disclosure.

FIG. 3 illustrates a current ratio diagram of different branches of the light-emitting device illustrated in FIG. 2.

FIG. 4 illustrates an equivalent circuit diagram of another light-emitting device in an embodiment of the disclosure.

FIG. 5 illustrates an equivalent circuit diagram of still another light-emitting device in an embodiment of the disclosure.

FIG. 6 illustrates a schematic diagram of a planar structure of the light-emitting device in the embodiment of the disclosure.

FIG. 7 illustrates a schematic diagram of a planar structure of the another light-emitting device in the embodiment of the disclosure.

Description of reference numerals: 10. light-emitting device; 122. first light source; 124. second light source; 12. first branch; 126. shunt; 142. third light source; 14. second branch; 121. first shunt; 123. second shunt; 125. third shunt; 127. fourth shunt.

### DETAILED DESCRIPTION OF EMBODIMENTS

The following will combine the drawings in the embodiments of the disclosure to provide a clear and complete description of the technical solutions in the embodiments of the disclosure. It is evident that the described embodiments are only part of the embodiments of the disclosure, not all of them. Based on the embodiments in the disclosure, all other embodiments obtained by those skilled in the art without creative work are within the scope of protection of the disclosure.

It should be noted that the terms “first,” “second,” “an end,” etc., used in the specification and claims of the disclosure, are intended to distinguish similar objects and are not necessarily used to describe a specific order or sequence. It should be understood that such terms, when used in this manner, are interchangeable in appropriate circumstances so that the embodiments of the disclosure described here can be implemented in an order other than that illustrated or described here. Furthermore, the terms “include” and “contain” and their conjugations are intended to cover non-exclusive inclusion, meaning that a process, a system, a product, or a device that includes a series of steps or units is not limited to those steps or units clearly listed but may include other steps or units that are not clearly listed or are inherent to the process, the product, or the devices.

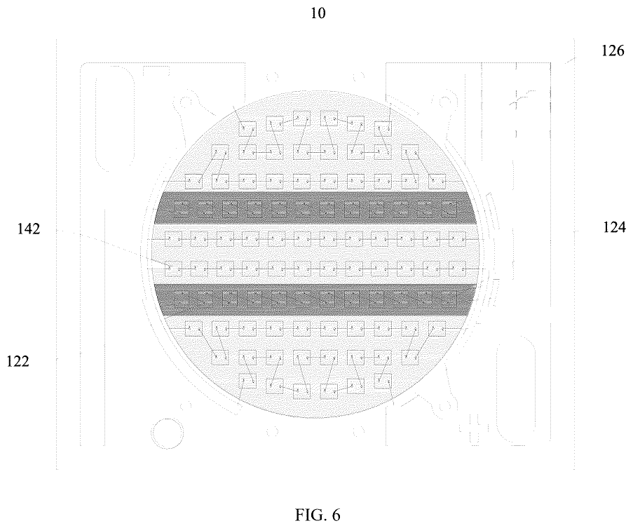

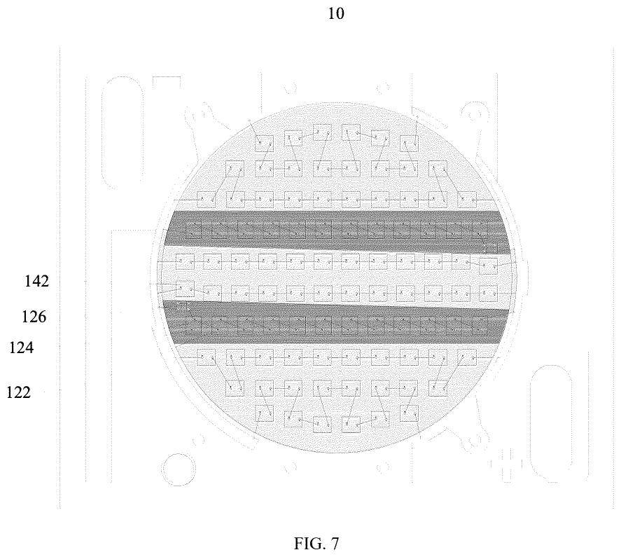

In an embodiment, as shown in FIGS. 6 and 7, a light-emitting device 10 is provided. An equivalent circuit diagram of the light-emitting device 10 is as shown in FIG. 2. The light-emitting device 10 includes a first light source 122, a second light source 124, a third light source 142 and a shunt 126. The second light source 124 is connected in series with the first light source 122, and the second light source 124 and the first light source 122 form a first branch 12. The shunt 126 is connected in parallel with the second light source 124 and in series with the first light source 122. The third light source 142 is connected in parallel with the first branch 12, for example, the third light source 142 can be electrically connected to the same electrode of the light-emitting device 10 as the first branch 12. Moreover, the color temperature of the light emitted by the third light source 142 is different from that of the first branch 12. This allows for the color temperature of the light emitted by the light-emitting device 10 to gradually increase until it stabilizes during the process of the light-emitting device 10 being progressively illuminated. In some embodiments, a color temperature of the third light source 142 is higher than that of the first light source 122 and the second light source 124.

The light-emitting device 10 provided in the embodiment of the disclosure includes the second light source 124 and the shunt 126 connected in parallel. This arrangement allows that, after the light-emitting device 10 is powered on, as a total current of the light-emitting device 10 gradually increases in a certain range, the first light source 122 starts to work first, and the shunt 126 shorts the second light source 124. Then, the third light source 142 begins to work, at which point the overall color temperature of the light-emitting device 10 is a mixed color temperature of the first light source 122 and the third light source 142, that is, between the color temperatures of the light emitted by the first light source 122 and the third light source 142. As the total current further increases, the second light source 124 lights up and works, participating in the color temperature regulation of the light-emitting device 10, which further increases the color temperature of the light-emitting device 10. And after the color temperature of the light-emitting device 10 reaches a certain predetermined value, the total current of the light-emitting device 10 continues to increase. The second light source 124 typically has the same color temperature as the first light source 122. Compared with some traditional dimming circuits that do not have a second light source 124, the light-emitting device 10 of the disclosure generates less heat from the shunt 126 under higher operating currents, making the entire light-emitting device 10 more energy-efficient.

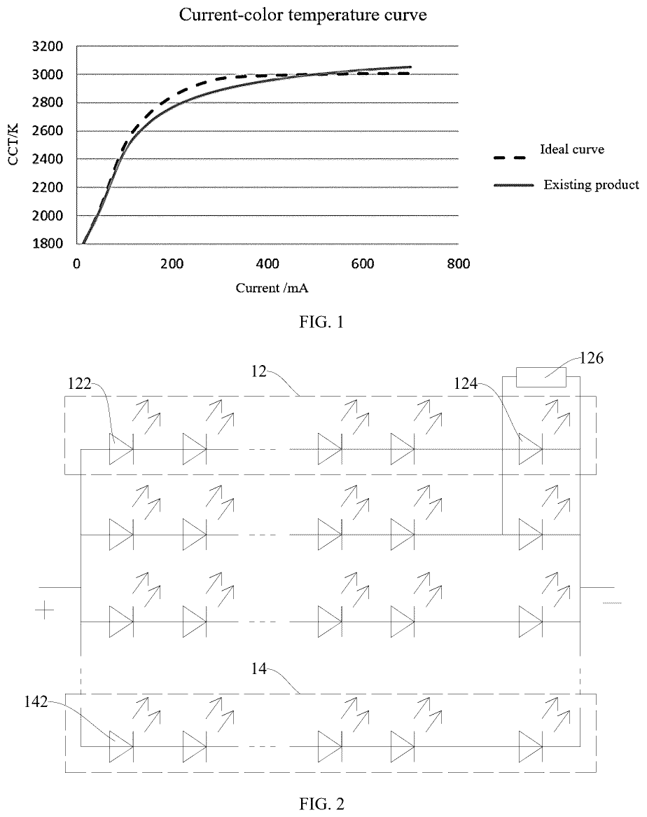

In conclusion, the light-emitting device 10 provided by the embodiment of the disclosure sets the first light source 122, the third light source 142, and the second light source 124 to illuminate sequentially. The arrangement allows the overall color temperature of the light-emitting device 10 to gradually shift from the color temperature of the first light source 122 to that of the third light source 142, thereby simulating the color temperature gradient process of an incandescent bulb gradually lighting up. Additionally, the light-emitting device 10 will stably output a color temperature within a certain current or power range, which is the mixed output color temperature of the first light source 122, the second light source 124, and the third light source 142. Thus, the light-emitting device 10 provided by the embodiment of the disclosure can achieve a color temperature change towards the color temperature of the third light source 142 under an input current of 0-x milliampere (mA). When the current exceeds x mA, the color temperature of the light-emitting device 10 remains unchanged, as shown in an ideal curve shown in FIG. 1. When the current is in a range of 0 to 400 mA, the overall color temperature of the light-emitting device 10 shifts towards 3000 K, and when the current is greater than 400 mA, the overall color temperature of the light-emitting device 10 will remain stable at 3000 K, distinguishing it from existing product solutions. Therefore, the light-emitting device 10 provided by the embodiment of the disclosure can cover the application requirements under different currents to meet the needs of different customers, thus satisfying the customized product needs and power distribution settings of different customers. The value of x mentioned above can be adjusted by changing the resistance of the shunt 126, the number of the second light source 124, and a ratio of the first branch 12 to the second branch 14, as detailed in the following embodiments.

In an embodiment, the first light source 122, the second light source 124, and the third light source 142 include various diode light-emitting elements such as light-emitting diode (LED). A combination of the LED and fluorescent adhesive can also serve as the first light source 122, the second light source 124, and the third light source 142. The shunt 126 includes, for example, a resistor or a conductive element with a certain resistance value. The first light source 122, the second light source 124, and the third light source 142 are taken as examples with the LEDs as the main light-emitting bodies. Starting voltages of the first light source 122, the second light source 124, and the third light source 142 can be set to different values. For example, the starting voltage of the third light source 142 can be set between the starting voltage of the first light source 122 and a sum of the starting voltages of the first light source 122 and the second light source 124. Alternatively, the starting voltages of the first light source 122, the second light source 124, and the third light source 142 can be the same, there are multiple the third light sources 142, and the multiple third light sources 142 are connected in series to form a second branch 14 connected in parallel with the first branch 12.

By providing the multiple third light sources 142, the ratio of color temperature between the first branch 12 and the second branch 14 can be adjusted. As the number of third light sources 142 gradually increases, the overall color temperature of the light-emitting device 10 will shift towards the color temperature of the third light source 142.

In an embodiment, when the number of the third light sources 142 is multiple, the number of the second branches 14 can be multiple, and the multiple second branches can be connected in parallel with each other. A power supply connected to the light-emitting device 10 typically has a maximum output voltage available for its use. For example, if the maximum output voltage is 36 volts (V) and the starting voltage of the third light source 142 is 3 V, then the maximum number of third light sources 142 that can be connected in series in a single second branch 14 is 12. By setting up the multiple second branches 14, the number of third light sources 142 can be further increased, thus allowing the overall color temperature of the light-emitting device 10 to shift even more towards the color temperature of the third light source 142.

In an embodiment, as shown in FIG. 2, the number of the first light sources 122 is multiple, and the multiple first light sources 122 are connected in series, and the multiple first light sources 122 are connected in series with at least one second light source 124 to form the first branch 12. By providing the multiple first light sources 122, the overall color temperature of the light-emitting device 10 can be shifted towards the color temperature of the first light source 122. Additionally, the number of the first light sources 122 and the number of the third light sources 142 can be multiple, thereby increasing the overall luminous intensity of the light-emitting device 10.

In an embodiment, when the number of the first light sources 122 is multiple, the number of the first branches 12 can also be multiple, the multiple first branches 12 are connected in parallel with each other. This allows for the addition of more first light sources 122 to adjust the overall color temperature and luminous intensity of the light-emitting device 10, within the constraint of a limited maximum voltage from the power supply.

Specifically, the first light source 122, the second light source 124, and the third light source 142 can, for example, use the same type of LED, but achieve different color temperatures by covering the corresponding light sources with different ratios of phosphor. In an embodiment, the color temperatures of the first branch 12 and the second branch 14 can be set to different values, which are specifically realized by setting the color temperatures of the first light source 122, the second light source 124, and the third light source 142. For example, in the light-emitting device 10, the color temperatures of the first light source 122 and the second light source 124 can be greater than or equal to 1500 K and less than or equal to 2100 K; and the color temperature of the third light source 142 can be greater than or equal to 3100 K and less than or equal to 3300 K. More specifically, if the color temperatures of the first light source 122 and the second light source 124 are, for example, 1800 K, and the color temperature of the third light source 142 is 3200 K, then the overall color temperature of the light-emitting device 10 will be between 1800 K and 3200 K. The specific value depends on the number of the first light source 122, the second light source 124, and the third light source 142.

In an embodiment, the color temperature of the third light source 142 is greater than that of both the first light source 122 and the second light source 124. The number of the third light sources 142 is greater than a total number of the first light sources 122 and the second light sources 124. As a result, the overall color temperature of the light-emitting device 10 will shift towards the color temperature of the third light source 142, thereby exhibiting a higher color temperature.

Specifically, taking the equivalent circuit of the light-emitting device shown in FIG. 2 as an example, the light-emitting device 10 includes multiple first light sources 122, the multiple first light sources 122 are connected in series, and the multiple first light sources 122 are connected in series with the second light source 124 to form the first branch 12. A number of the first branch 12 is multiple, the multiple first branches 12 are connected in parallel, and a ratio of the number of the first branches 12 and the number of the second branches 14 can be, for example, 1:3. Each first branch 12 includes multiple first light sources 122 and one second light source 124. Each second branch 14 includes multiple third light sources 142. The number of third light sources 142 in any second branch 14 is equal to the total number of first light sources 122 and the second light source 124 in any first branch 12. The first light source 122, second light source 124, and third light source 142 include LED elements with the same starting voltage. For example, the light-emitting device 10 includes two first branches 12 and six second branches 14. Each first branch 12 includes 11 first light sources 122 and 1 second light source 124, and each second branch 14 includes 12 third light sources 142.

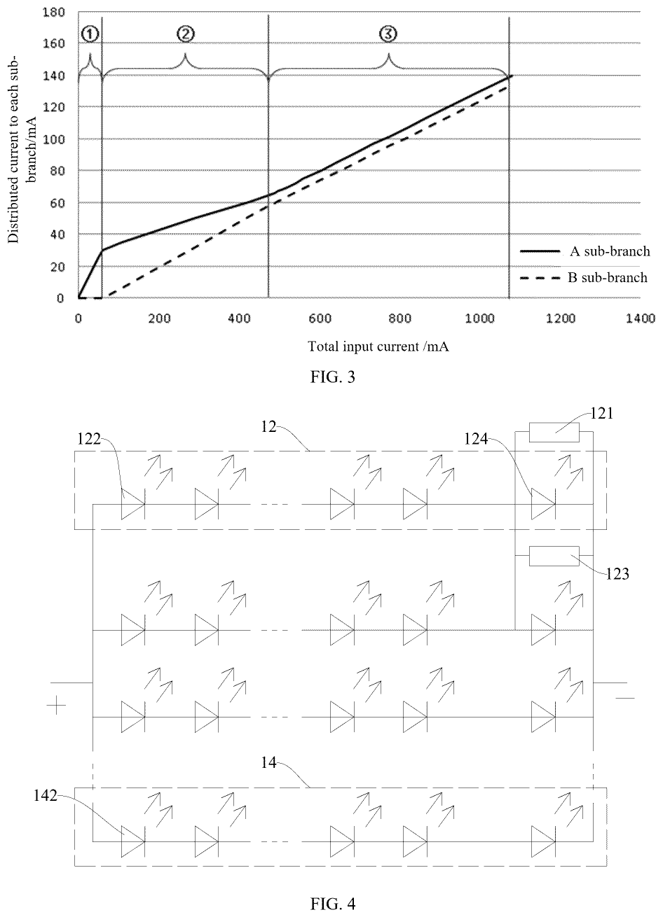

A working process of the light-emitting device 10 is illustrated through the equivalent circuit shown in FIG. 2. In the equivalent circuit, a total voltage is applied on two sides by the power supply. The first light source 122, the second light source 124, and the third light source 142, for example, include LED elements with the same starting voltage, and the color temperature of the first light source 122 is the same as that of the second light source 124, while the color temperature of the third light source 142 is greater than that of the first light source 122 and the second light source 124. When the total voltage has not reached the total starting voltage of the multiple first light sources 122 connected in series in the first branch 12, neither the first branch 12 nor the second branch 14 conducts electricity. As the total voltage rises and reaches the total starting voltage of the multiple first light sources 122 connected in series in the first branch 12, the multiple first light sources 122 in the first branch 12 conduct electricity. The corresponding conducting current passes through the shunt 126, and the shunt 126 shorts the second light source 124. At this time, only the multiple first light sources 122 in the two first branches 12 are lit up, and the color temperature of the light-emitting device 10 is the same as that of the first light source 122, for example, 1800 K. The above process corresponds to the ideal curve at a color temperature of 1800 K shown in FIG. 1. At this time, the total current of the light-emitting device 10 corresponding to the total voltage is relatively low. More specifically, as shown in FIG. 3, the two first branches 12, for example, form an A branch, and the six second branches 14 form a B branch. Each first branch 12 is an A sub-branch, and each second branch 14 is a B sub-branch. A first segment (i.e., \textcircled{1})) in FIG. 3 corresponds to the light-emitting device 10 when only the first light sources 122 are lit up. At this time, only the first branches 12 have the conducting currents, and the sum of the currents of the two first branches 12 is the total current corresponding to the total voltage.

As the total voltage further increases and reaches the starting voltage of the multiple third light sources 142 in the second branch 14, all the third light sources 142 in the second branch 14 light up. At this point, the overall color temperature of the light-emitting device 10 is a mixed color temperature of the first light sources 122 and the third light sources 142. Since the number of second branches 14 is greater than the number of first branches 12, as the total voltage continues to rise, the overall color temperature of the light-emitting device 10 will gradually increase and shift towards the color temperature of the third light source 142, as shown in the ideal curve of FIG. 1. Moreover, as shown in a second segment (i.e., \textcircled{2}) of FIG. 3, the proportion of the current of the second branch 14 in the total current will gradually increase; and a slope of the A sub-branch is less than a slope of the B sub-branch. During the above process, due to the shunt 126 being connected in parallel with the second light source 124 and the voltage division effect of the shunt 126 and the multiple first light sources 122, the second light source 124 has not yet conducted electricity.

More specifically, as the total voltage continues to rise, the second light source 124 in the first branch 12 will be conducted electricity. When the second light source 124 operates in the linear region, the conducting current of the second light source 124 will significantly increase with the voltage. Due to the illumination of the second light source 124, the overall color temperature of the light-emitting device 10 will slightly shift towards the color temperature of the second light source 124. Since the second light source 124 typically has the same color temperature as the first light source 122, this helps to suppress the overall color temperature from shifting towards the color temperature of the third light source 142. At this point, as shown in FIG. 3, the slope of the A sub-branch will increase, and correspondingly, the slope of the B sub-branch will decrease. The two current proportion curves in FIG. 3 transition from the second segment to a third segment. In the third segment (i.e., \textcircled{3}) of the curve in FIG. 3, the slopes of the A sub-branch and the B sub-branch are the same, meaning that as the total voltage and the total current rise, the current ratio between the A branch and the B branch remains unchanged. That is, the ratio between the luminous intensity of the A branch and the B branch remains constant. As a result, the overall color temperature of the light-emitting device 10 will be maintained at a preset value and remain stable. For example, in the current range of 400 mA to 600 mA as shown in FIG. 1, the overall color temperature of the light-emitting device 10, as indicated by the ideal curve, stabilizes at 3000 K, and its color temperature change does not exceed 3% during this phase.

Additionally, if the ratio between the first branch 12 and the second branch 14 changes, the ideal curve shown in FIG. 1 will also change. For example, if the ratio between the first branch 12 and the second branch 14 is adjusted to 1:1, and the first branch 12 and the second branch 14 are provided with 4 branches respectively, the slope of the curve during the color temperature rise phase in the diagram will decrease. This means that as the total current increases, the color temperature change of the light-emitting device 10 will slow down. If a stable stage is desired at a lower current, this can be achieved by increasing the number of the first branch 12 relative to the second branch 14, or by increasing the resistance value of the shunt 126. However, increasing the resistance value will cause the color temperature to start changing at a lower current. To maintain the original setting, it is necessary to increase the number of second light sources 124 connected in parallel (for example, changing from 11 first light sources 122 and 1 second light source 124 connected in parallel with the shunt 126 to 10 first light sources 122 and 2 second light sources 124 connected in parallel with the shunt 126).

Additionally, as shown in FIG. 2, the shunt 126 is connected in parallel with the second light sources 124 in the multiple first branches 12. Alternatively, as shown in FIG. 4, the number of the shunt is multiple, and the multiple shunts are connected in parallel with the second light sources 124 in the multiple first branches 12 in a one-to-one manner. The multiple shunts, for example, the first shunt 121 and the second shunt 123 shown in FIG. 4, can be equivalent to the single shunt 126 shown in FIG. 2. For example, if the resistance of the shunt 126 in FIG. 2 is 20 ohms (Ω), then in FIG. 4, the resistance of the first shunt 121 and the second shunt 123 can be set to 40Ω, and due to their actual parallel relationship, they are equivalent to a 20-ohm resistor. The light-emitting device 10, as shown in FIG. 6 or FIG. 7, has various electrical components as shown in FIG. 2 or FIG. 4 set on a substrate. Alternatively, due to the limited area of the substrate, to save space on the substrate occupied by the shunt, a single shunt 126 setting as shown in FIG. 2 can be adopted. If the substrate area is enough, or based on the distribution requirements of the shunt and the light sources, a circuit structure with multiple shunts as shown in FIG. 4 can also be used.

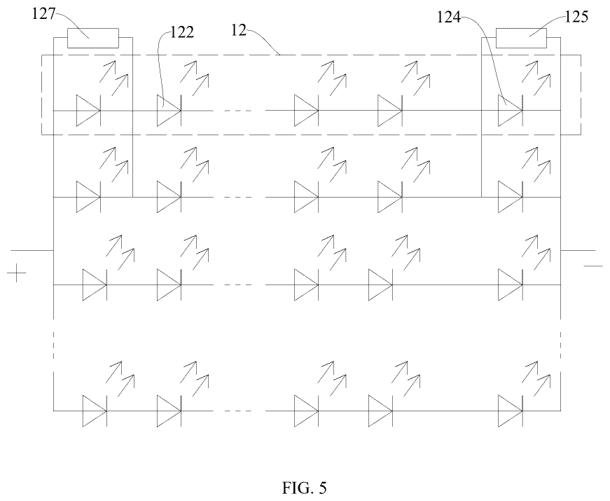

In an embodiment, as shown in FIG. 5, based on the need for symmetrical distribution of certain light sources, the light-emitting device 10 may include multiple shunts, each first branch 12 includes multiple second light sources 124, and the multiple shunts are respectively connected in parallel with the multiple second light sources 124. The multiple shunts, as shown in FIG. 5, are the third shunt 125 and the fourth shunt 127. In this embodiment, each shunt can be connected in parallel with one second light source 124 of the multiple first branches 12 at the same time, or each shunt can be only connected in parallel with one second light source 124 in one first branch 12. The specific setting of the shunt is not limited to the implementations listed above and can be appropriately combined or adjusted according to the specific needs of the light-emitting device 10.

As shown in FIGS. 6-7, the light-emitting device 10, for example, is a chip on board (COB) type of packaged product. The LED elements contained in the first light source 122, the second light source 124, and the third light source 142 are all attached to the die-bonding area on a COB substrate. Subsequently, a first fluorescent adhesive is applied to the LED elements corresponding to the first light source 122 and the second light source 124, and a second fluorescent adhesive is applied to all the LED element corresponding to the third light source 142, thereby forming the first light source 122, the second light source 124, and the third light source 142. In an embodiment, the shunt 126 can be set outside the die-bonding area as shown in FIG. 6. In another embodiment, the shunt 126 can be set within the die-bonding area as shown in FIG. 7. This arrangement depends on the specific choice of the shunt 126. In other embodiments of the disclosure, the first light source 122, the second light source 124, and the third light source 142 can also be set on the COB substrate in the form of chip scale package (CSP). Certainly, the light-emitting device 10 provided by the disclosure is not limited to the COB type packaged product, which can also be filament-type packaged products or a combination of surface mounted device (SMD) type packaged products.

Furthermore, it can be understood that the above embodiments are only illustrative of the disclosure, and the technical solution of each embodiment can be arbitrarily combined and used in combination, provided that the technical features do not conflict, are fixed and not contradictory, and do not violate the inventive purpose of the disclosure.

Finally, it should be noted that the above embodiments are only used to illustrate the technical solutions of the disclosure, and not to limit them. Although the disclosure has been described in detail with reference to the above embodiments, those skilled in the art should understand that they can still modify the technical solutions described in the above embodiments, or equivalently replace some of the technical features. These amendments or substitutions do not depart from the essence and scope of the corresponding technical solutions of the embodiments of the disclosure.

What is claimed is:

1. A light-emitting device (10), comprising:
a first light source (122),
a second light source (124), wherein the second light source (124) is connected in series with the first light source (122), and the second light source (124) and the first light source (122) form a first branch (12);
a shunt, wherein the shunt is connected in parallel with the second light source (124) and connected in series with the first light source (122); and
a third light source (142), wherein the third light source (142) is connected in parallel with the first branch (12), and a color temperature of the third light source (142) is different from that of the first branch (12).

2. The light-emitting device (10) as claimed in claim 1, wherein a number of the third light source (142) is multiple, the multiple third light sources are connected in series to form a second branch (14), and the second branch (14) is connected in parallel with the first branch (12).

3. The light-emitting device (10) as claimed in claim 2, wherein a number of the second branch (14) is multiple, and the multiple second branches (14) are connected in parallel.

4. The light-emitting device (10) as claimed in claim 1, wherein a number of the first light source (122) is multiple, the multiple first light sources (122) are connected in series, and the multiple first light sources (122) are connected in series with at least one second light source (124) to form the first branch (12).

5. The light-emitting device (10) as claimed in claim 2, wherein a number of the first light source (122) is multiple, the multiple first light sources (122) are connected in series, and the multiple first light sources (122) are connected in series with at least one second light source (124) to form the first branch (12).

6. The light-emitting device (10) as claimed in claim 3, wherein a number of the first light source (122) is multiple, the multiple first light sources (122) are connected in series, and the multiple first light sources (122) are connected in series with at least one second light source (124) to form the first branch (12).

7. The light-emitting device (10) as claimed in claim 4, wherein a number of the first branch (12) is multiple, and the multiple first branches (12) are connected in parallel.

8. The light-emitting device (10) as claimed in claim 7, wherein the shunt is simultaneously connected with the second light sources (124) of the multiple first branches (12) in parallel.

9. The light-emitting device (10) as claimed in claim 7, wherein a number of the shunt is multiple, and the multiple shunts are respectively connected in parallel with the multiple second light sources (124) of the multiple first branches (12) in a one-to-one manner.

10. The light-emitting device (10) as claimed in claim 7, wherein a number of the shunt is multiple, and the multiple shunts are connected in parallel with the multiple second light sources (124) of the multiple first branches (12) respectively.

11. The light-emitting device (10) as claimed in claim 4, wherein a number of the third light source (142) is multiple, the color temperature of the multiple third light sources (142) is greater than that of the multiple first light sources (122) and the second light source (124); the number of the third light sources (142) is greater than a total number of the multiple first light sources (122) and the second light source (124).

12. The light-emitting device (10) as claimed in claim 5, wherein the color temperature of the multiple third light sources (142) is greater than that of the multiple first light sources (122) and the second light source (124); the number of the third light sources (142) is greater than a total number of the multiple first light sources (122) and the second light source (124).

13. The light-emitting device (10) as claimed in claim 6, wherein the color temperature of the multiple third light sources (142) is greater than that of the multiple first light sources (122) and the second light source (124); the number of the third light sources (142) is greater than a total number of the multiple first light sources (122) and the second light source (124).

14. The light-emitting device (10) as claimed in claim 3, wherein a number of the first light source (122) is multiple, the multiple first light sources (122) are connected in series, and the multiple first light sources (122) and the second light source (124) form the first branch (12);
a number of the first branch (12) is multiple, and the multiple first branches (12) are connected in parallel; each of the multiple first branches (12) comprises the multiple first light sources (122) and one second light source (124); each of the multiple second branches (14) comprises the multiple third light sources (142); the number of the multiple third light sources (142) in each of the multiple second branches (14) is the same as a sum of a number of the multiple first light sources (122) and the second light source (124) in each of the multiple first branches (12); and
the multiple first light sources (122), the second light source (124) and the multiple third light sources (142) comprise light-emitting diode elements with the same starting voltage.

15. The light-emitting device (10) as claimed in claim 1, wherein the color temperature of the first light source (122) and the color temperature of the second light source (124) are greater than or equal to 1500 Kelvin (K) and less than or equal to 2100 K; the color temperature of the third light source (124) is greater than or equal to 3100 K and less than or equal to 3300 K.

16. The light-emitting device (10) as claimed in claim 2, wherein the color temperature of the first light source (122) and the color temperature of the second light source (124) are greater than or equal to 1500 K and less than or equal to 2100 K; the color temperature of the multiple third light source (124) is greater than or equal to 3100 K and less than or equal to 3300 K.

17. The light-emitting device (10) as claimed in claim 14, wherein the color temperature of the multiple first light source (122) and the color temperature of the second light source (124) are greater than or equal to 1500 K and less than or equal to 2100 K; the color temperature of the multiple third light source (124) is greater than or equal to 3100 K and less than or equal to 3300 K.

18. The light-emitting device (10) as claimed in claim 1, wherein the first light source (122) the third light source (142), and the second light source (124) light up sequentially in that order as a total current of the light-emitting device (10) gradually increases.

19. The light-emitting device (10) as claimed in claim 2, wherein the first light source (122) the multiple third light source (142), and then the second light source (124) light up sequentially in that order as a total current of the light-emitting device (10) gradually increases.

20. The light-emitting device (10) as claimed in claim 14, wherein the multiple first light source (122), the multiple third light source (142), and the second light source (124) light up sequentially in that order as a total current of the light-emitting device (10) gradually increases.
